(19) United States
(12) Patent Application Publication
(10) Pub. No.: US 2006/0174214 A1
(43) Pub. Date: Aug. 3, 2006

(54) System and method for navigation of content in multiple display regions

(76) Inventors: Timothy P. McKee, Seattle, WA (US); Judson Craig Hally, Sammamish, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(21) Appl. No.: 10/639,911

(22) Filed: Aug. 13, 2003

(51) Int. Cl. G06F 3/00

(52) U.S. Cl. 715/802; 715/786; 715/792

(57) ABSTRACT

A system and method for a user interface which allows for the navigation of content in multiple display regions. Each of two or more sets of content is associated with regions on a display. A unitary navigation control enables simultaneous navigation of the two or more sets of content in response to a user input. A scrollbar may aid user interaction with the navigation control, and the navigation control may permit navigation of the sets of content at uniform or variable rates. A system and method for a user interface which allows for the navigation of one set of content while a second, related set of content remains static.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to the field of user interfaces for use with a computer system. More particularly, the present invention relates to a system and a method for providing an improved user interface that allows for the navigation of content in multiple display regions.

### BACKGROUND OF THE INVENTION

Providing users of computers with useful and understandable controls for navigating content presented upon a computer display has become increasingly complex as today's software seeks to place a greater quantity of useful information on a computer screen. To facilitate this increase in displayed content, software developers often divide a display area into multiple regions called panes. For example, Microsoft Corporation's WINDOWS® 2000™ operating system includes a utility named WINDOWS® EXPLORER™ which enables users to browse a file system by providing a first pane showing the folders in the file systems and second pane displaying the contents of a selected folder. Such a display allows the user simultaneously to view the location of a particular file on the computer and to view the details of a selected folder.

FIG. 2 shows a screen display known in the art that utilizes a multi-pane environment. A display screen 200 is divided into two panes, a first pane 206 and a second pane 208. Content in the pane 206 is navigated via user interaction with a scrollbar 202, while content in the pane 208 is navigated via user interaction with a scrollbar 204. WINDOWS®EXPLORER™ utilizes a multiple scrollbar environment similar to the one shown in FIG. 2.

Another example of a multi-pane environment is found in WINDOWS®PAINT™, a software application included with the WINDOWS® 2000™ operating system. PAINT™, which is capable of viewing image files, includes a thumbnail view pane that allows a user to simultaneously view different perspectives of an image. While navigation on the main pane causes related navigation in the thumbnail view pane, each of these panes displays a different view of the same image and the image cannot be navigated independently within the thumbnail view pane. Similarly, software applications which allow for viewing of relational databases or tree structures often display multiple views of the same set of content; one pane may display the high level organization of the data, while a second pane may show the details of a lower level. A limitation of these various display schemes is that users cannot navigate multiple sets of content with a single input.

Many users find it difficult to navigate content in multi-pane environments such as the screen display shown in FIG. 2. This difficulty is aggravated when multiple panes have content that is initially out of view. The use of multiple scrollbars may confuse a user in that a user may not understand which scrollbar navigates in a desired pane. Furthermore, multiple scrollbars lead to visual clutter and decrease the display area available for content.

The multi-pane environment also leads to diminished user interaction with content not originally presented on a screen. Such “hidden” content is viewable only when a user affirmatively navigates to the information. For instance, a user may never scroll down in a certain pane and, thus, will never become aware of that pane's “hidden” content. Often in multi-pane environments the user must proactively seek out the content in each pane, and thus, never becomes aware of useful information hidden out of view.

Another problem with the prior art is that high priority content is often scrolled out of view making it more difficult for a user to utilize such content. For example, two frequently used items of content may be located such that the user is forced to constantly navigate to and from such content. This frequent scrolling leads to inefficiency and decreased usability of a computer system. In a multi-pane environment, the utility of the screen area must be optimized, and thus, navigation away from such high value content is undesirable.

Accordingly, there is a need for an improved user interface that eliminates the user confusion associated with the multi-pane environment. There is also a need for an interface that provides for greater interaction with available content. Finally, there is a need for techniques that provide a mechanism for keeping certain higher priority items always in view.

### SUMMARY OF THE INVENTION

The present invention meets the above needs and overcomes one or more deficiencies in the prior art by providing a user interface in which multiple display regions may be navigated by a unitary navigation control. One aspect of the present invention is a graphical user interface embodied on a computer-readable medium and executable on a computer. The graphical user interface includes a navigation control that allows simultaneous navigation of two or more sets of content in response to a user input. In an exemplary embodiment, the present invention provides a single scrollbar, and a user may scroll through multiple sets of content by interaction with the single scrollbar. This user interface eliminates the need for multiple scrollbars and increases the likelihood that “hidden” content will be placed in a user's view.

In a further aspect of the present invention, a computer-implemented method is provided which performs user-requested navigational actions on a plurality of sets of content. One such method includes receiving a user input representing a navigational action and performing said navigational action simultaneously on two or more sets of content.

In still a further aspect of the present invention, a navigation control for simultaneously scrolling through multiple panes on a display screen is provided. This control includes a user input component for obtaining the desired scrolling direction and a rate component for determining scrolling rates for each of the multiple panes. The user input and the scrolling rates are used by an output component for generating instructions for executing a navigation action on multiple panes.

In another aspect of the present invention, a computer-implemented method is provided which performs navigational actions on a first set of content without performing any navigational actions on a second, related set of content.

In a further aspect of the present invention, a graphical user interface is provided which includes related sets of content. While a set of content is navigated via a navigation control, the other set of content is remains static with respect to the pane in which it is displayed.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a screen display of a prior art user interface utilizing multiple navigation controls;

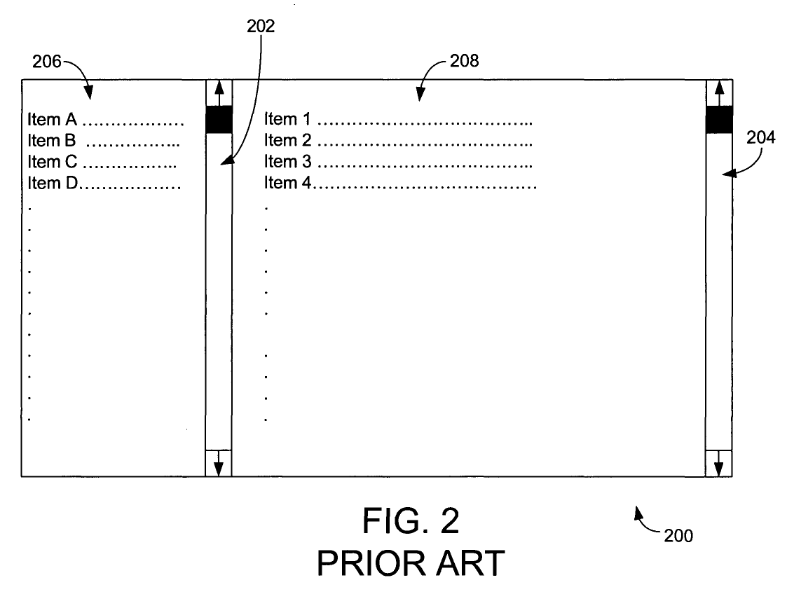

FIG. 3 is a screen display of a graphical user interface in accordance with one embodiment of the present invention in which a single navigation control is utilized;

FIG. 4A-4C are diagrams of an exemplary graphical user interface for a navigation control in accordance with one embodiment of the present invention in which variable scroll rates are utilized;

FIG. 5A-5E are diagrams of an exemplary graphical user interface for a navigation control in accordance with one embodiment of the present invention in which interruption instructions affect the navigation;

FIG. 6 is a block diagram of a navigation control in accordance with one embodiment of the present invention;

FIG. 7 is a screen display of a graphical user interface in accordance with one embodiment of the present invention having a third pane that is not scrollable;

FIG. 8 is a flow diagram showing a method for navigation of content in accordance with one embodiment of the present invention; and

FIG. 9 is a flow diagram showing a method for navigation of content in accordance with one embodiment of the present invention.

### DETAILED DESCRIPTION OF THE INVENTION

The present invention provides an improved user interface that allows for the navigation of content in multiple regions of a display device. An exemplary operating environment for the present invention is described below.

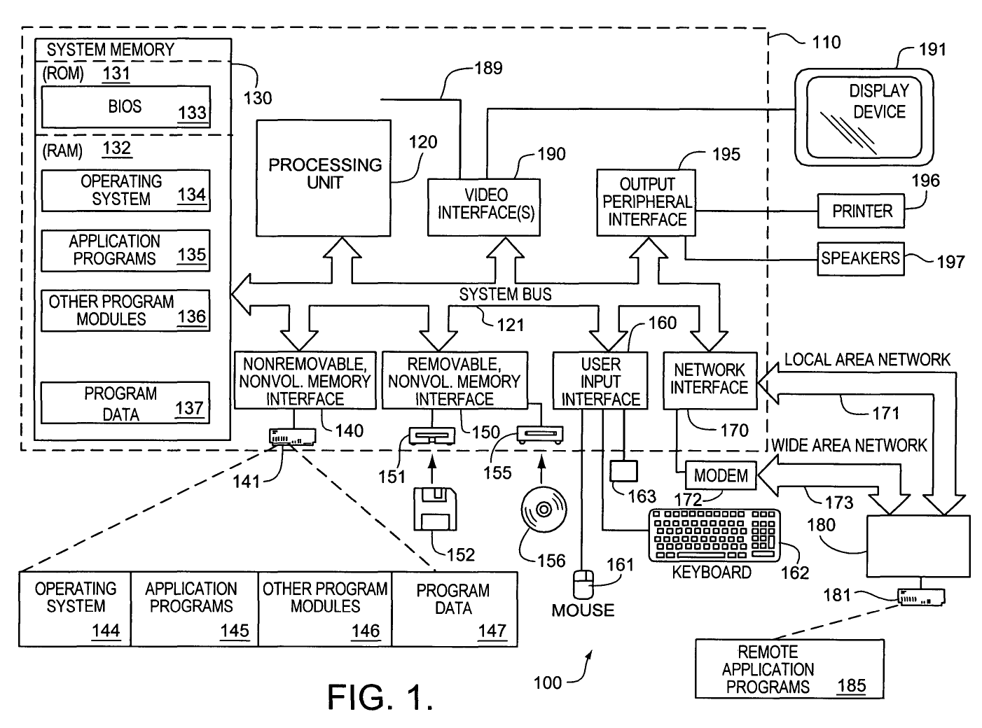

Referring to the drawings in general and initially to FIG. 1 in particular, wherein like reference numerals identify like components in the various figures, an exemplary operating environment for implementing the present invention is shown and designated generally as operating environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. The invention may also be practiced in distributed-computing environments where tasks are performed by remote-processing devices that are linked through a communications network. In a distributed-computing environment, program modules may be located in both local and remote computer-storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory 130 to the processing unit 120.

Computer 110 typically includes a variety of computer-readable media. By way of example, and not limitation, computer-readable media may comprise computer-storage media and communication media. Examples of computer-storage media include, but are not limited to, Random Access Memory (RAM); Read-Only Memory (ROM); Electronically Erasable Programmable Read-Only Memory (EEPROM); flash memory or other memory technology; CD-ROM, digital versatile discs (DVD) or other optical or holographic disc storage; magnetic cassettes, magnetic tape, magnetic disk storage or other magnetic storage devices; or any other medium that can be used to store desired information and be accessed by computer 110. The system memory 130 includes computer-storage media in the form of volatile and/or nonvolatile memory such as ROM 131 and RAM 132. A Basic Input/Output System 133 (BIOS), containing the basic routines that help to transfer information between elements within computer 110 (such as during start-up) is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer-storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD-ROM or other optical media. Other removable/nonremovable, volatile/nonvolatile computer-storage media that can be used in the exemplary operating environment include, but are not limited to, magnetic tape cassettes, flash memory units, digital versatile disks, digital video tape, solid state RAM, solid state ROM, and the like. The hard disk drive 141 is typically connected to the system bus 121 through a nonremovable memory interface such as interface 140. Magnetic disk drive 151 and optical disc drive 155 are typically connected to the system bus 121 by a removable memory interface, such as interface 150.

The drives and their associated computer-storage media discussed above and illustrated in FIG. 1 provide storage of computer-readable instructions, data structures, program modules and other data for computer 110. For example, hard disk drive 141 is illustrated as storing operating system 144, application programs 145, other program modules 146, and program data 147. Note that these components can either be the same as or different from operating system 134, application programs 135, other program modules 136, and program data 137. Typically, the operating system, application programs and the like that are stored in RAM are portions of the corresponding systems, programs or data read from hard disk drive 141, the portions varying in size and scope depending on the functions desired. Operating system 144, application programs 145, other program modules 146, and program data 147 are given different numbers here to illustrate that, at a minimum, they can be different copies. A user may enter commands and information into the computer 110 through input devices such as a keyboard 162; pointing device 161, commonly referred to as a mouse, trackball or touch pad; a wireless-input-reception component 163; or a wireless source such as a remote control. Other input devices (not shown) may include a microphone, joystick, game pad, satellite dish, scanner, or the like. These and other input devices are often connected to the processing unit 120 through a user-input interface 160 that is coupled to the system bus 121 but may be connected by other interface and bus structures, such as a parallel port, game port, IEEE 1.394 port, or a universal serial bus (USB), or infrared (IR) bus.

A display device 191 is also connected to the system bus 121 via an interface, such as a video interface 190. Display device 191 can be any device to display the output of computer 110 not limited to a monitor, an LCD screen, a Thin Film Transistor (TFT) screen, a flat-panel display, a conventional television, or screen projector. In addition to the display device 191, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local-area network (LAN) 171 and a wide-area network (WAN) 173 but may also include other networks, such as connections to a metropolitan-area network (MAN), intranet, or the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. Modem 172 could be a cable modem, DSL modem, or other broadband device. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnections are well-known. For example, including various expansion cards such as television-tuner cards and network-interface cards within a computer 110 is conventional. Accordingly, additional details concerning the internal construction of the computer 110 need not be disclosed in connection with the present invention.

When the computer 110 is turned on or reset, the BIOS 133, which is stored in ROM 131, instructs the processing unit 120 to load the operating system, or necessary portion thereof, from the hard disk drive 141 into the RAM 132. Once the copied portion of the operating system, designated as operating system 144, is loaded into RAM 132, the processing unit 120 executes the operating-system code and causes the visual elements associated with the user interface of the operating system 134 to be displayed on the display device 191. Typically, when an application program 145 is opened by a user, the program code and relevant data are read from the hard disk drive 141 and the necessary portions are copied into RAM 132, the copied portion represented herein by reference numeral 135.

As previously mentioned, the present invention may be described in the general context of computer-useable instructions. Computer-useable instructions include functions, procedures, schemas, routines, code segments, and modules useable by one or more computers or other devices. The computer-useable instructions form an interface to allow a computer to react according to a source of input. The instructions cooperate with other code segments to initiate a variety of tasks in response to data received in conjunction with the source of the received data.

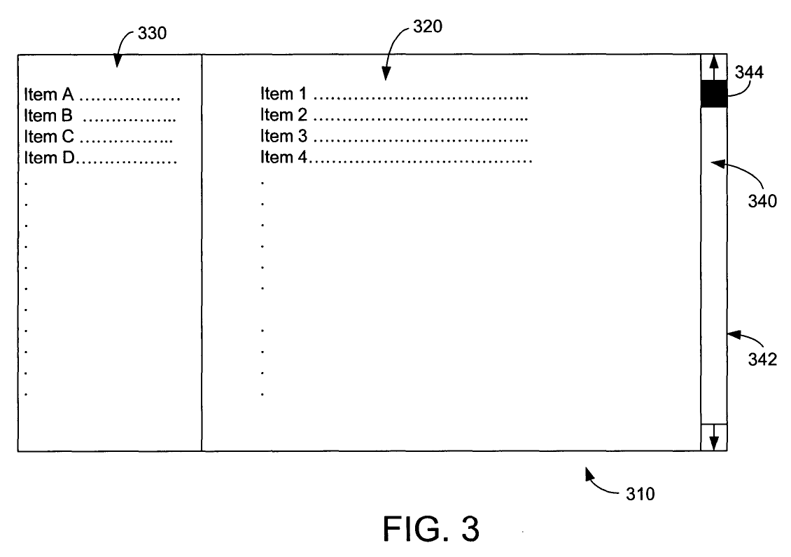

Turning to FIG. 3, a screen display 310 provides an exemplary screen view in accordance with one embodiment of the present invention. Other embodiments of the invention allow for output on a plurality of display devices.

The present invention allows for navigation of content through user interaction with a navigation control. A user may input commands into the navigation control through interaction with a scrollbar 340. Such interaction may be via a variety of input devices including a mouse, a keyboard and a screen with user input capability. Those skilled in the art will appreciate that the scrollbar 340 is a visual aid which assists a user in the navigation of content and that a scrollbar is not necessary to practice the instant invention. For example, user input to the navigation control may be accepted through keyboard navigation controls such “Page Up” or through utilization of a mouse scroll wheel. Furthermore, while the scrollbar 340 is a vertical scrollbar, those skilled in the art will appreciate that scrollbars which other orientations, such as horizontal, are also applicable to the current invention.

Display 310 is divided into display regions 320 and 330. The display regions 320 and 330 each present a set of content that may be navigated via interaction with the scrollbar 340. FIG. 3 demonstrates an exemplary display scheme in which the region 320 displays one list of information and the region 330 displays a second list. The two sets of information may be associated with each other or may be completely unrelated.

Navigation of the sets of content associated with the regions 320 and 330 is accomplished through user interaction with the scrollbar 340. The scrollbar 340 comprises a scrollbar column 342 and a scroll indicator 344. Such scrollbars are widely known in the art. Content is moved into or out of the display regions by displacement of the scroll indicator 344 within the column 342.

Upon receiving a user input indicating a navigational direction, the content displayed in the regions 320 and 330 is scrolled. The regions 320 and 330 each have an associated set of content. A portion of this content is initially viewable on the display 310, while a portion remains “hidden” until a user navigates to it. For example, referring to FIG. 3, a single downward displacement of the scroll indicator 344 will cause the uppermost items in the regions 320 and 330 to be scrolled out of view. Simultaneously, the upper most items of hidden content will be moved onto the bottom of the viewable regions. While FIG. 3 demonstrates two regions navigated by a single user input, the invention contemplates any number of display regions on any number of display devices.

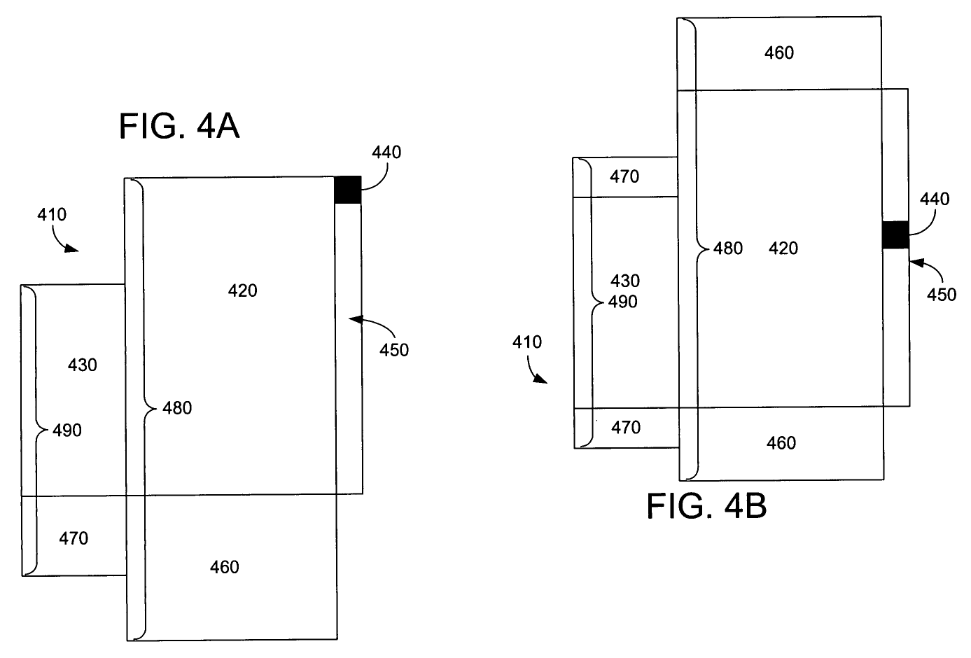

The navigation resulting from a user input may be varied according to the present invention. For example, the speed in which the content in a display region is scrolled may differ from region to region. In one embodiment, the content in each region is scrolled at an independent rate depending upon the ratio of display area versus the area of the unseen content. FIGS. 4A, 4B, and 4C show a display 410 and illustrate such a scrolling scheme. In FIG. 4A, a set of content is associated with a display region 420 and a different set of content is associated with a display region 430. Each display region presents a portion of its respective of content, while the remaining content in the set is “hidden” out of view. An area 460 contains the unviewed content associated with the region 420, and an area 470 is the area necessary to display the unviewed content associated with the content displayed in region 430. An area 480 is the sum of the region 420 and the area 460; this area represents the total area necessary to view the set of content associated with the region 420. Similarly, the area 490 represents the total area necessary to view the set of content associated with the region 430. The areas 480 and 490 each may be referred to as the “content area” for their respective sets of content. In FIG. 4A, a scrollbar indicator 440 is at the initial, uppermost position, and thus, all unviewed content resides below the viewable regions 420 and 430.

Turning now to FIG. 4B, the scrollbar indicator 440 has been moved to the middle of the scrollbar column 450. Such movement has caused approximately half of the previously unviewed content to be navigated into the viewable regions 420 and 430. The areas 460 and 470, which are now located both above and below their respective display regions, contain content that is not currently viewable to a user. FIG. 4C shows the scrollbar indicator 440 moved to the bottom of the scrollbar column 450. As a result, the lowermost portion of the content area associated with regions 420 and 430 has been moved into the viewable display, while the hidden content of the areas 460 and 470 now resides completely above the viewable regions.

To achieve the scrolling scheme discussed above, the rate of content scrolling for each individual display region must be calculated. Generally, the smaller the fraction of viewable area of a display region versus the content area, the greater the rate of content scrolling. For example, if two display regions of equal size have content associated with them with viewable areas of 10 square inches and 20 square inches, the region with the 20 square inches will have a scroll rate that is approximately twice the speed of the other region.

The rate of content scrolling refers to the displacement of an item of content per navigational input. For example, a navigational input may comprise a one-inch displacement of a scroll indicator in a scroll column. If such displacement causes an individual item of content on the display to travel 2 inches, the scrolling rate is 2 inches of content displacement per one inch of scroll indicator displacement.

As an example and returning to FIG. 4A, assume the region 420 is 10 square inches, the region 430 is 5 square inches, the area 480 is 40 square inches, and the area 490 is 10 square inches. The fraction of viewable area of display region 420 (10 square inches) versus the total area necessary to view the set of content (40 square inches) is 1 to 4. This dictates that for a complete scroll of region 420, four distinct sets of content must be shown on the display region. In contrast, region 430 has 5 square inches of viewable area versus 10 square inches of content area yielding a ratio of 1 to 2. A complete scroll in region 430 only yields two distinct displays of content. Hence, the content in region 420 will appear to scroll approximately twice as quickly as the content in region 430. The above calculations are provided only for illustration and those skilled in the art will recognize that many other scroll rate formulas may be utilized in accordance with the present invention.

When a scrollbar is utilized to control the navigation, the dimensions of the scrollbar may also be considered when determining the scroll rate. The ratio of displacement experienced by the scroll indicator versus the scroll column length may relate to the rate of content displacement in the various display regions.

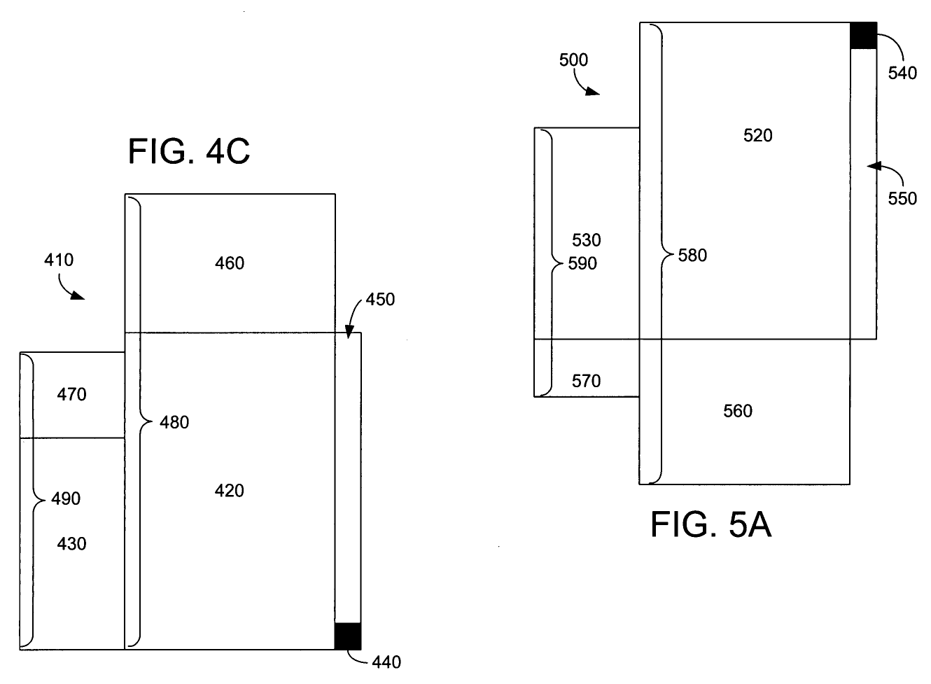

In another embodiment of the invention, the navigation in a particular region may be suspended while the navigation continues in other panes. FIGS. 5A-5E illustrate one such embodiment. FIG. 5A shows display regions 520 and 530 of a screen display 500 and hidden areas 560 and 570. The areas 560 and 570 represent the area needed to view the “hidden” content associated with regions 520 and 530 respectively. An areas 580 is the content area of the set of content associated with the region 520, while an area 590 is the content area of the set of content associated with the region 530.

Interruption instructions associated with this embodiment dictate that, when the final element of a set of content is navigated onto the display region, the navigation in that display region will cease until the navigational direction instructions are changed. Similarly, the instructions provide that navigation will cease when the first content element is navigated onto the top of the display region. FIG. 5A shows the display 500 with the sets of content in an initial position with no scrolling, as indicated by a scrollbar indicator 540 being in the uppermost position of a scrollbar 550.

Turning now to FIG. 5B, the results of a partial scroll are illustrated. As shown at the lower border 510 of the region 530, there is no remaining available content to be scrolled through the region 530, while the lower portion of area 560 demonstrates that the region 520 continues to have content yet to be viewed. Because the final element of content in the region 530 has reached the lower border 510, navigation of the region 530 has been interrupted as dictated by the interruption instructions.

FIG. 5C demonstrates further navigation of the display 500. The region 530 remains completely scrolled and navigation will not resume as to that region until the navigational direction is reversed. Meanwhile, scrolling has continued in the region 520. Referring now to FIG. 5D, this figure displays a complete scrolling of content in the regions 520 and 530 in that all available content now resides above the regions 520 and 530. Accordingly, the interruption instructions have caused navigation to cease for each region and scrolling cannot resume until the user changes the navigational direction, i.e. requests upward scrolling. FIG. 5E illustrates the result of such an upward command. As shown in the lower portion of the regions 560 and 570, previously viewed content is moved off of the display regions as the scrollbar indicator 540 is moved upward. The foregoing demonstrates the use of interruption instructions to suspend navigation in a display region, and those skilled in the art will appreciate that numerous interruption instructions may be utilized in accordance with this invention. Such instructions may vary from region to region and may act independently on a single region or on a plurality of such regions.

Embodiments of the present invention may have a uniform scroll rate shared by two or more display regions. In one embodiment where a uniform scroll rate is utilized, the scroll rate is computed with reference to the display region with the longest content length. A region's content length refers to the displacement experienced by a content element over a complete scroll; it is the distance the final element of hidden content must travel to reach the lower edge of the display region. In the case of vertical scrolling, such a length is computed by dividing the content area of a set of content by the width of a display region. For horizontal scrolling, such a length is computed by dividing the content area of a set of content by the height of a display region. Once the content length for each display region is calculated, the display region with the greatest content length is used to calculate the uniform scroll rate. This rate may be a function of the content length and the length of the scroll column. For example, the rate may be calculated such that the set of content in the display region with the greatest content length will not achieve a complete scroll until the scroll indicator has traveled the entire length of the scrollbar. As expected, the other sets of content may achieve a complete scroll before the scroll indicator reaches the bottom of the scroll column because such sets, scrolling at a constant rate, have shorter content lengths.

Those skilled in the art will appreciate that the instant invention may be just one aspect of a user interface's navigational scheme. For example, additional navigation controls may be included in the user interface. These additional navigation controls may allow a user to navigate an individual set of content independently. For example, one embodiment may provide both a scrollbar according to the instant invention and additional functionality which allows for scrolling of an individual set of content in response to a user's utilization of a mouse scroll wheel or keyboard navigation controls. In another example, the navigational control of the instant invention may include the ability to suspend navigation of a set of content in response to a user input. Such controls may “freeze” the scrolling in a certain pane, while allowing navigation to continue for a single user input in the other regions. The above examples are merely for illustration and any number of additional navigational controls or combinations thereof may be utilized with the current invention.

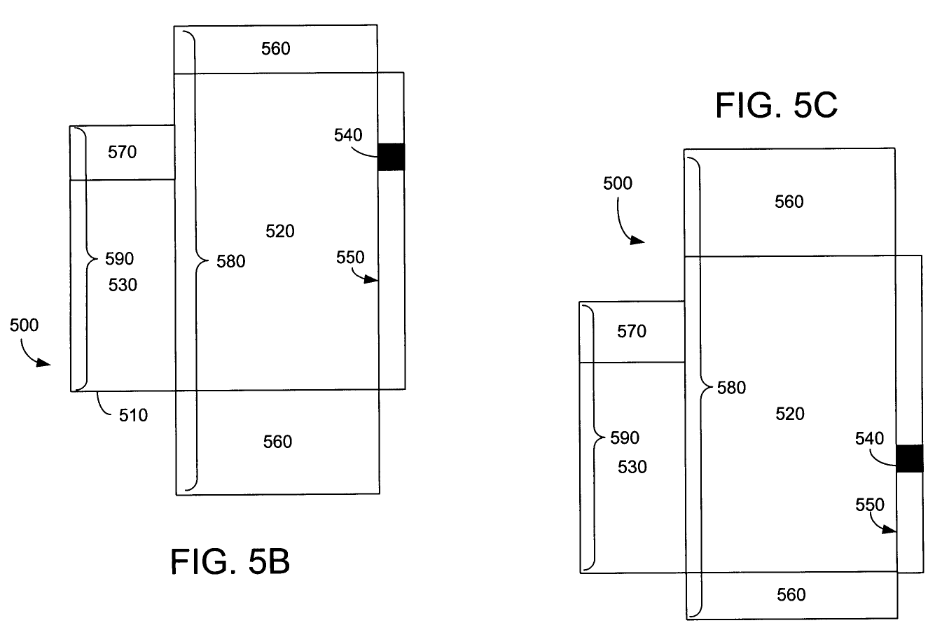

Turning to FIG. 6, a block diagram of a navigation control 600 in accordance with the present invention is shown. The navigation control 600 has a user input component 610 for obtaining data indicative of a scrolling direction. Such input may be via one or more of a variety of input devices and may involve interaction with a scrollbar and/or the use of keyboard navigation controls. The navigation control 600 also comprises a rate component 620 for determining scrolling rates for each of the multiple panes. The scroll rates may be uniform for all panes or may be variable. In the case of variable rates, the rate component 620 may assign scrolling rates to each of the multiple panes as a function of factors such as the multiple panes' respective pane areas and their respective content areas. An output component 640 is also included in the navigation control 600. The output component 640 uses the input data and the determined scrolling rates to generate instructions for executing a navigation action. An optional element to navigation control 600 is an interrupt component 630 for suspending scrolling in each of the multiple panes when an interrupt condition is fulfilled. Once the interrupt component 630 suspends navigation in a pane, the user must input a change to the navigational direction before navigation is reinitiated in that pane.

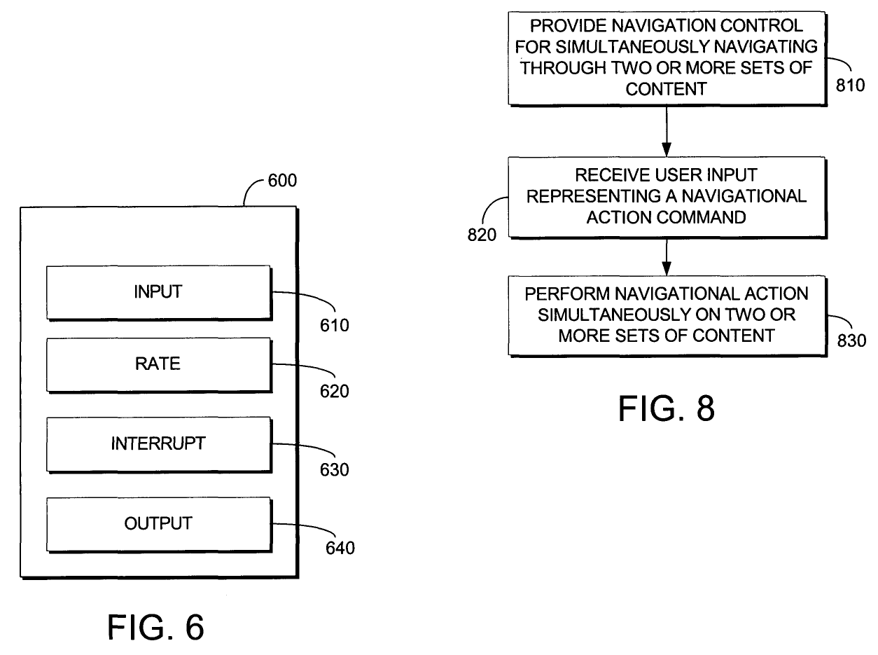

FIG. 7 is a screen display 700 showing yet another embodiment of the present invention. The screen display 700 is divided into a first pane 710, a second pane 720 and a third pane 730. The panes 720 and 730 are navigated by a unitary navigation control. This unitary navigation control provides for simultaneous navigation of the content in these panes in response to a user input. A user may utilize keyboard navigation controls or a scrollbar 740 to input navigational commands to the navigation control.

The pane 710 is not navigated via the unitary navigation control. The content shown in this pane remains static and viewable despite navigation in other panes. In one embodiment of the invention, pane 710 displays items of content which are related to the content in panes 720 and 730 and which navigation away from such items would be undesirable. A user or computer software program may place “frozen” content in the pane 710. The software may choose which items based off a determination that the items are of high utility to a user, which thus enables the user to scroll through the lower value content while continuing to view the higher value content. In one embodiment, items in the pane 710 are tasks which are associated with the content displayed in other panes on the screen display 700. In this embodiment, a user may click on an item of unfrozen content and drag it on to one of the tasks in the pane 710. Such action may cause the task to be preformed on the selected unfrozen content. Those skilled in the art will appreciate that the invention contemplates utilizing pane 710 with varying numbers of panes which are navigated by various types of navigational controls.

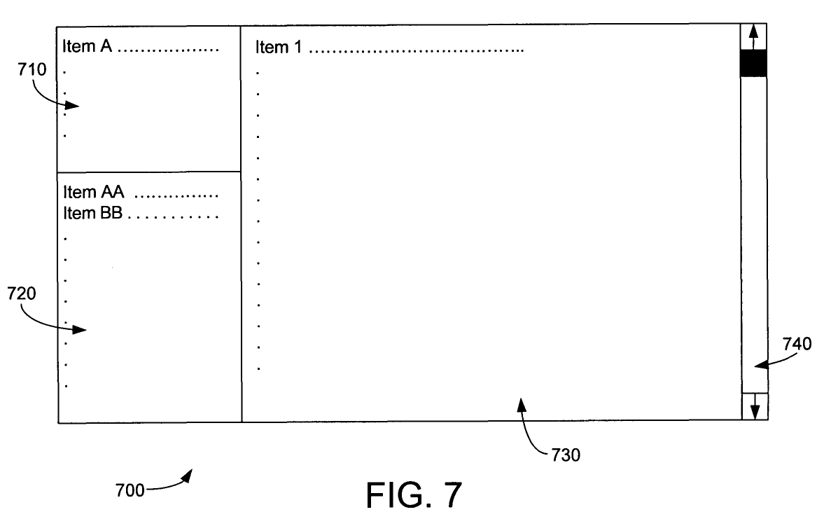

FIG. 8 is a flow diagram illustrating a method 800 for enabling a user to navigate two or more sets of content simultaneously in accordance with an embodiment of the present invention. At 810, the method 800 provides a unitary navigation control capable of simultaneously navigating two or more sets of content. Each set of content may be viewable on a display region and the content sets may be unrelated or related. At 820, a user inputs requesting a navigational action command is received. Such a command may be to scroll content in a certain direction.

At 830, the method 800 performs the input navigational action on two or more sets of content. Such navigation may be at a uniform rate across all display regions or at variable rates. In one embodiment of the present invention, the method 800 includes determining a scroll rate for each individual set of content. In determining such a scroll rate, the viewable area of a display region and the content area of the associated set of content may be considered. If the navigational control includes a scrollbar, the length of the scrollbar column may also be considered in a scroll rate calculation. In another embodiment, a set of interruption conditions may be determined. If such conditions are met for a set of content, the navigation of that set of content will be interrupted until the navigational input is altered.

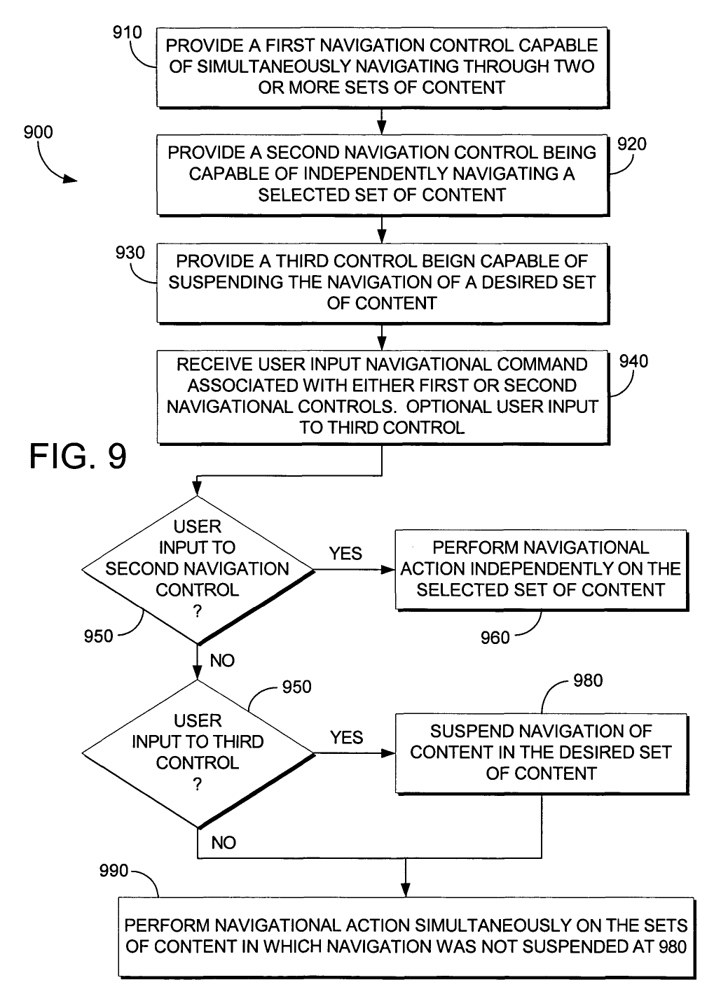

FIG. 9 is a flow diagram illustrating a method 900 for enabling a user to navigate two or more sets of content simultaneously in accordance with an embodiment of the present invention. At 910, the method 900 provides a first navigation control. This control is capable of simultaneously navigating two or more sets of content. At 920, the method 900 provides a second navigational control. This control is capable of independently navigating a desired set of content, perhaps including one of the two or more sets of content. At 930, the method provides an optional third control. This control allows for the suspension of navigation of a chosen set of content. This control will suspend the navigation of content in an individual set of content while other sets of content may be navigated freely. At 940, a user input is accepted. Such an input should be to either the first or second navigational controls. An optional input may be received by the third control. At 950, the method 900 determines whether the input was made to the second navigational control. If so, the input navigational action is performed independently on the desired individual set of content as provided at 960. At 970, the method determines whether an input has been made to the third control. If such an input has been made, the method will suspend the navigation of the chosen sets of content as provided at 980. At 990, the method performs the navigational action input to the first navigation control. Such navigation is performed simultaneously on each set of content that was not suspended at 980.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. A graphical user interface embodied on one or more computer-readable media and executable on a computer, said graphical user interface comprising:
a first content area associated with a first set of content, wherein at least a portion of the first set of content is viewable in a first display region within the first content area;
a second content area associated with a second set of content, wherein at least a portion of the second set of content is viewable in a second display region within the second content area; and
a unitary navigation control operatively coupled with the first and second content areas, wherein the unitary navigation control simultaneously provides for navigation of said first set of content and said second set of content in response to a single user input.

2. The user interface of claim 1, wherein said first set of content is not related to said second set of content.

3. The user interface of claim 1, further comprising a third content area associated with a third set of content, wherein a portion of said third content area is viewable on a third display region.

4. The user interface of claim 3, wherein said navigation control is operatively coupled with the third content area, and wherein said navigation control simultaneously provides for navigation of said first set of content, said second set of content, and said third set of content in response to a single user input.

5. The user interface of claim 1, wherein said user input is communicated via a mouse, a keyboard, and/or a screen with user input capability.

6. The user interface of claim 1, wherein said navigation control provides the graphical user interface means for scrolling content.

7. The user interface of claim 1, wherein said navigation control provides the graphical user interface with the ability to change which portion of said first content area is viewable on the first display region and to change which portion of said second content area is viewable on the second display region.

8. The user interface of claim 1, wherein said user input includes a navigational direction.

9. The user interface of claim 1, wherein the unitary navigation control simultaneously provides for the navigation of the first and second sets of content at different rates.

10. The user interface of claim 1, wherein the unitary navigation control provides for the navigation of the first set of content at a rate which is a function of:
the viewable area of said first display region; and
the area of said first content area.

11. The user interface of claim 10, wherein the unitary navigation control provides for the navigation of the second set of content at a rate which is a function of:
the viewable area of said second display region; and
the area of said second content area.

12. The user interface of claim 10, wherein said navigation control comprises a scrollbar including a scroll column and a scroll indicator.

13. The user interface of claim 12, wherein the unitary navigation control provides for the navigation of the first set of content at a rate which is a function of the length of said scrollbar column.

14. The user interface of claim 12, wherein the displacement of said scroll indicator with respect to the length of said scroll column corresponds to the fraction of the first set of content which passes through the portion of content viewable on the first display region.

15. The user interface of claim 14, wherein the displacement of said scroll indicator with respect to the length of said scroll column corresponds to the fraction of the second set of content which passes through the portion of content viewable on the second display region.

16. The user interface of claim 1, wherein said navigation control comprises:
a first set of interruption instructions associated with said first content area which provides for the interruption of scrolling in said first content area; and
a second set of interruption instructions associated with said second content area which provides for the interruption of scrolling in said second content area.

17. The user interface of claim 16, wherein said navigation control provides for the scrolling of content in at least one of said content areas until navigation in each of said content areas is interrupted by said interruption instructions.

18. The user interface of claim 17, wherein said navigation control resumes navigation in each of said content areas upon a change in said user input.

19. The user interface of claim 1, wherein said first and second sets of content each include a beginning content item and a final content item; and
wherein said first and second display regions each include a first border and a second border.

20. The user interface of claim 19, wherein said navigation control provides for the interruption of scrolling of said first set of content when the beginning content item is navigated to the first border of the first display region or when the final content item is navigated to the second border of the second display region.

21. The user interface of claim 1, wherein the unitary navigation control provides for the navigation of the first and second sets of content at a rate which is a function of:
the length of a scroll column; and
the content length of the display region with the greatest content length,
wherein the content length is the quotient of the area of the content area and the width of the display region associated with said content area.

22. The user interface of claim 1, further comprising a second navigation control operatively coupled to the first content area, wherein said second navigation control provides for the navigation of the first set of content in response to a user input independently of said unitary navigation control.

23. The user interface of claim 1, wherein said unitary navigation control allows for the suspension of navigation of a set of content in response to a user input.

24. A computerized method for navigating through two or more sets of content presented in a graphical user interface, said method comprising:
providing a unitary navigation control capable of simultaneously navigating through two or more sets of content;
receiving a user input representing a navigational action to be performed with respect to at least one of said two or more sets of content; and
performing said navigational action simultaneously on said two or more sets of content.

25. The method of claim 24, wherein said two or more sets of content comprise:
a first set of content viewable on a first display region of the graphical user interface; and
a second set of content viewable on a second display region of the graphical user interface.

26. The method of claim 25, wherein said first set of content is not related to said second set of content.

27. The method of claim 24, wherein performing said navigational action includes scrolling through the two or more sets of content.

28. The method of claim 24, wherein performing said navigational action comprises:
determining a scroll rate for each individual of said two or more sets of content; and
simultaneously scrolling said sets of content at the determined scroll rate.

29. The method of claim 28, wherein the determined scroll rate for an individual set of content is a function of:
the viewable area of a display region associated with said individual set of content; and
the area necessary to view said individual set of content on said display region.

30. The method of claim 29, wherein said navigation control comprises a scrollbar including a scroll column and a scroll indicator; and
wherein said input comprises displacement of said scroll indicator in said scroll column.

31. The method of claim 30, wherein said determined scroll rate for an individual set of content is a function of:
the length of said scrollbar column.

32. The method of claim 24 wherein performing said navigational action includes:
determining a set of interruption conditions;
determining if said interruption conditions are met in each individual set of content;
interrupting the navigation of an individual set of content when said interruption conditions are fulfilled.

33. The method of claim 32, wherein performing said navigational action includes resuming navigation of each set of content when the input is changed.

34. The method of claim 24, wherein performing said navigational action includes scrolling each of said sets of content at a uniform rate.

35. The method of claim 24, wherein said method further comprises:
providing a control capable of suspension of navigation of a set of content in an individual display region.

36. The method of claim 24, wherein said method further comprises:
providing a control capable of independently navigating content in an individual display region.

37. One or more computer-readable media having computer-executable instructions for performing the method of claim 24.

38. An operating system stored on one or more computer-readable media, the operating system including the graphical user interface of claim 1.

39. A navigation control for simultaneously scrolling through multiple panes on a display screen, the navigation control comprising:
a user input component for obtaining data indicative of a scrolling direction;
a rate component for determining scrolling rates for each of the multiple panes; and
an output component for generating instructions for executing a navigation action, said output associated with said data and said scrolling rates.

40. The navigation control of claim 39 further comprising an interrupt component for suspending scrolling in each of the multiple panes when an interrupt condition is fulfilled.

41. The navigation control of claim 39 wherein the rate component assigns a uniform scrolling rate to each of the multiple panes.

42. The navigation control of claim 39 wherein the rate component assigns scrolling rates to each of the multiple panes as a function of their respective pane areas and their respective content areas.

43. A navigation control for simultaneously scrolling through multiple panes on a display screen, the navigation control comprising:
means for obtaining data indicative of one or more user inputs representing a navigation action;
means for determining the scrolling rates for each of the multiple panes; and
means for executing the navigation action in accordance with said data and said scrolling rates on said multiple panes.

44. A computerized method for presenting two or more sets of content on a graphical user interface, said method comprising:
displaying at least a portion of a first set of content in a first display region, said first set of content including content for which navigation is available;
displaying a second set of content in a second display region, said second set of content including content which is related to said first set of content and for which navigation is not available;
providing a navigation control operably coupled to said first display region and capable of navigating said first set of content;
receiving a user input representing a navigational action to be performed with respect to the first display region; and
performing said navigation action on said first set of content without performing any navigational action with respect to the second display region.

45. The method of claim 44, wherein said second set of content is a subset of said first set of content.

46. The method of claim 44, wherein an element of said second set of content is chosen based upon a determination that said element should always remain visible on a display.

47. The method of claim 46, wherein said determination is made by a user.

48. The method of claim 46, wherein said determination is made by a computer software program.

49. The method of claim 44, wherein an element of said second set of content is chosen based upon a determination that said element has high utility to a user.

50. The method of claim 44, wherein said second set of content is a set of the tasks which are associated with said first set of content.

51. A graphical user interface embodied on one or more computer-readable media and executable on a computer, said graphical user interface comprising:
a first display pane associated with a first set of content, wherein at least a portion of the first set of content is viewable on said first display pane;
a navigation control which is operably coupled with said first display pane, said navigation control being operable to navigate said first set of content on said first display pane; and
a second display pane associated with a second set of content, wherein the second set of content is viewable on said second display pane;
wherein the second set of content is related to said first set of content and wherein the second set of content is static with respect to the second display pane.

52. The method of claim 51, wherein an element of said second set of content is chosen based upon a determination that said element should always remain visible on a display.
